(19) United States
(12) Patent Application Publication
(10) Pub. No.: US 2003/0214938 A1
(43) Pub. Date: Nov. 20, 2003

(54) Method for routing of label switched paths (LSPS) through an internet supporting multi-protocol label switching (MPLS) technology

(76) Inventors: Deepak Kumar Jindal, Pune (IN); Joy Kuri, Bangalore (IN); Anurag Kumar, Bangalore (IN)

Correspondence Address: John M. Kelly, The Law Firm of John M. Kelly, 2117 L Street, NW #347, Washington, DC, 20037, US

(21) Appl. No.: 10/388,765

(22) Filed: Mar. 17, 2003

(30) Foreign Application Priority Data
Mar. 21, 2002 (IN) 273/DEL/2002

(51) Int. Cl. H04L 12/28

(52) U.S. Cl. 370/351; 370/468

(57) ABSTRACT

The Internet has evolved to a stage where it is expected to support transfer of not only elastic traffic but also real-time traffic with delay, jitter and loss guarantees. Upon the arrival of a request it is necessary to find a path through the network that has sufficient capacity—this is referred to as ‘routing’. It is essential to set up Virtual Paths through a network of routers. Such Virtual Paths are called Label switched Paths (LPs) in MPLS terminology. The arrived request for ingress-egress pair (S,D)₁ must be routed along a single (unsplit) path in such a way that the minimum unsplit flow between all other ingress-egress pairs is maximized; here all other ingress-egress pairs have traffic flowing simultaneously. Thus explaining the name Maximum Minimum Additional Flow Routing Algorithm (MMAFRA).

MMAFRA has 2 phases:

1. Off Line Phase

a) Enumerate all paths for all ingress-egress pairs.

b) For each pair obtain the set of links utilized by one or more paths by that pair. This set is called the ‘link set’ for that pair.

c) For each link, obtain its ‘weight’ as the number of all ingress-egress pairs whose link sets contain that link.

2. On Line Phase

It begins with the arrival of a bandwidth demand for the ingress-egress pair (j) with a bandwidth demand of D (say). Then

a) Eliminate all links, which have residual capacities less than D units and obtain a reduced network.

b) Update the weight of each link in the reduced network by considering the residual capacity of the link; the weight should increase as the residual capacity decreases.

c) Use the updated weights and apply Dijkstra's algorithm to compute the least—weight path for the ingress-egress pair (j).

d) The route for the LSP request is given by the least-weight path above. Finally, the residual capacities of links in the least-weight path are also up-dated.

### CROSS REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF INVENTION—FIELD OF INVENTION

The invention relates to a method for routing of Label Switched Paths (LSPS) through an internet supporting Multi-Protocol Label Switching (MPLS) technology.

Maximum Minimum Additional Flow Routing Algorithm (MMAFRA).

The Internet has evolved to a stage where it is expected to support transfer of not only elastic traffic but also real-time traffic with delay, jitter and loss guarantees. In this scenario where guarantees must be provided, there is a need to reserve network resources before information transfer begins, so that packets of information generated by real-time applications receive adequate service from the network. Network resources like bandwidth and butter space are reserved along an end-to-end path, called a Virtual Path, connecting the source and destination through the network. Although the concepts of Virtual Paths and Virtual Circuits have been known for some time, the arrival of Multi-Protocol Label Switching (MPLS) technology has revived interest in techniques for setting up Virtual Paths through a network of routers. These Virtual Paths are called Label Switched Paths (LSPs) in MPLS terminology.

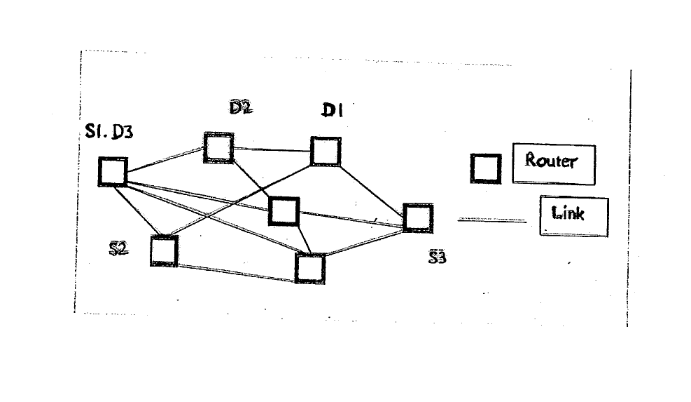

The scenario considered by the inventors is as follows: Consider a backbone network, consisting of routers and links, as shown in FIG. 1, which in the accompanying illustration is an example backbone network showing ingress and egress routers. Some of the routers behave as ingress points (or “sources” S) for traffic into the backbone, while some behave as egress points (or “destinations” D). It is possible for the same router to behave as both ingress and egress.

For the problem of routing traffic in a backbone network, the natural granularity for measuring traffic is aggregate flows and not individual session micro-flows. The need is to route aggregate flows between ingress and egress points, and the route assigned to an aggregate flow is referred to as a Label Switched Path. The bandwidth demand of an aggregate flow in the backbone is obtained from the bandwidth demands of numerous non-persistent session micro-flows between individual sources and destinations. Henceforth, the inventors also use the term “traffic request” to mean an aggregate flow.

Arriving traffic requests specify a source-destination pair and the amount of bandwidth needed. Upon the arrival of a request, it is necessary to find a path through the network that has sufficient capacity—this is referred to as “routing”. It is also usually necessary to route the entire flow along a single path; in other words, a flow cannot be split among several paths. In case a path of appropriate capacity cannot be found, the arriving request has to be denied service or “rejected”. It is the goal of any routing algorithm to reject as few requests as possible.

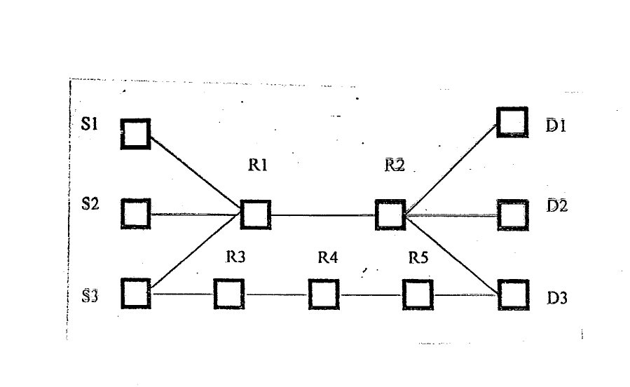

A variety of routing algorithms have been proposed and some have been widely implemented. The “Minimum Hop” (MH) routing algorithm is well-known. However, there are situations where the MH algorithm is inadequate; an example is given in FIG. 2, which in the accompanying illustration is an example network where Min-Hop Routing does not perform well.

In this example, suppose that all links are of capacity C units. If a request of bandwidth C units for (S3, D3) arrives, then the MH algorithm would route the request on the path S3-R1-R2-D3, since that path has the minimum number of hops (3). However, this means that future requests for (S1, D1) or (S2, D2) have to be rejected, because the bottleneck link between R1 and R2 has no spare capacity left. So in this network it may be better to route the initial request for (S3, D3) on the path S3-R3-R4-R5-D3, even though there are 4 hops on this path. This example shows that simple algorithms may not be sufficient. Algorithms that take network topology information and location of sources and destinations into account may be needed in order to reduce the chances of rejecting LSP requests.

In the following, the inventors discuss several MPLS routing algorithms that have appeared in the literature. The inventors have considered only “greedy” algorithms, that is, algorithms that accept LSP requests whenever possible. In general, a routing algorithm may reject an LSP request even when it is possible to admit it, because the revenue obtained by accepting the LSP request is small. The motivation is that the algorithm would rather not accept a low-revenue LSP request to conserve resources for a high-revenue LSP request that may arrive in the future. This type of method must be provided a “revenue table” giving the revenues obtainable by accepting different LSP requests. In this work, however, the inventors do not consider revenues explicitly, restricting their attention to greedy methods only.

The “residual capacity” of a link is defined to be the difference between the capacity of the link and the sum of the bandwidth demands of Lisps that have already been routed through that link. A new LSP can be routed along a link only if the residual capacity of the link exceeds the bandwidth requested by the new LSP. Such links are called “feasible” with respect to the given LSP demand. When computing routes, it is enough to consider feasible links only.

1. Minimum Hop (MH) routing [1]. In this algorithm, a path from the ingress to the egress with the least number of feasible links is chosen. As has been seen, this simple algorithm can lead to congestion on certain links and thereby increased LSP rejection ratios.

2. Shortest Widest Path (SWP) routing [2]. This algorithm finds paths from the ingress to the egress with the largest residual capacity (“widest” paths). The width of a path is given by the residual capacity of the link with the least residual capacity, i.e, the “bottleneck” link. When several such paths exist, it chooses one with the least number of feasible links. Studies have shown that the SWP algorithm can often choose long paths and thereby consume large amounts of network resources. This leaves less resources for future LSP requests and thereby increases chances of rejection.

3. Widest Shortest Path (WSP) routing [3]. This algorithm is a refinement of the MH algorithm. It obtains a set of paths from ingress to egress with the least number of feasible links. When several such paths exist, it chooses one with the largest residual capacity. WSP routing performs better than SWP routing, but it is itself outperformed by another algorithm (MIRA, see below) proposed in the literature.

4. Least Loaded Routing (LLR) [4]. In this algorithm, the least utilized feasible path from a set of candidates is chosen to route the new request. The scheme attempts to distribute load among the candidate routes. A drawback of this algorithm is “fragmentation”, where some capacity remains unutilized on many paths, leading to inefficient use of network resources.

5. Maximally Loaded Routing (MLR) [5]. This algorithm is motivated by the need to avoid fragmentation in LLR. It is based on the opposite idea, viz., “packing” of requests wherever possible on paths in the candidate set. Therefore, the most heavily utilized feasible path from the candidate set is chosen. The performance of this algorithm can depend on the choice of the set of candidate routes. If the set is large, then it is possible that an admitted request will consume unnecessarily more network resources because it is routed on a longer path.

6. Minimum Interference Routing Algorithm (MIR) [6]. This recently proposed algorithm takes explicit note of the locations of ingress-egress pairs and the topology of the network. The basic idea is to route a request along a path that causes least “interference” to the next request for some other ingress-egress pair. This is done by identifying a set of “critical” links, where a link is defined to be critical for an ingress-egress pair if it belongs to any min-cut for that ingress-egress pair. In the simplest case, the weight of a critical link is obtained by counting the number of ingress-egress pairs for which that link is critical. After obtaining the critical links, the algorithm chooses a feasible path with the least weight. A drawback of this algorithm is that it is computationally expensive, because min-cuts for different ingress-egress pairs must be obtained. Also, it can be shown that MIRA will not perform well for Ring topologies, because it can choose the longer path (of the two possible in a Ring topology) between an ingress and an egress.

7. Profile-based Routing (PBR) [7]. This algorithm is based on the belief that “yesterday's traffic between an ingress-egress pair can serve as a good predictor for today's traffic” particularly in light of the fact that service providers aggregate a large number of flows. The predicted amounts of each class of traffic is called a “profile” of that traffic class. The basic idea is to reserve a fraction of the capacity of each link for each class of traffic, the fraction being calculated on the basis of the profiles. Thus, capacities of links are pre-allocated to different classes, and an arriving request of a given class can only utilise bandwidth that has been earmarked for that class. Since this algorithm relies on pre-allocated capacities, its performance will degrade when there is an unpredictable change in the overall traffic pattern.

Proposed Solution: The proposed algorithm is motivated by the MIRA algorithm above, but it addresses the shortcomings of MIRA. In MIRA, the “interference” caused by a particular route for an ingress-egress pair (S,D)1 is measured by the reduction in maxflow values between all other ingress-egress pairs. However, the maxflow concept considers all possible paths from an ingress to an egress; so the usual constraint of unsplittable flows is not respected. Thus, the reduction of maxflow values for other ingress-egress pairs is an indirect way of measuring the interference caused by a chosen route for (S,D)1.

The inventors' formulation of the routing problem is more direct. The arrived request for (S,D)1 must be routed along a single (unsplit) path in such a way that

(a) all other ingress-egress pairs can simultaneously have unsplit flows of at least x units between them,

(b) the value of x is maximised.

This can also be stated as: the arrived request for (S,D)1 must be routed along a single (unsplit) path in such a way that the minimum unsplit flow between all other ingress-egress pairs is maximised; here, all other ingress-egress pairs have traffic flowing simultaneously. This also explains the name Maximum Minimum Additional Flow Routing Algorithm (MMAFRA). The problem formulation leads to a constrained non-linear integer program which, however, is hard to solve efficiently as it belongs to the class of problems that are NP-Hard. Therefore, the inventors resort to a heuristic algorithm which provides very good performance and outperforms MIRA.

The algorithm has two phases: Off-Line and On-Line. It can be summarised as follows:

Off-Line Phase

1. Enumerate all paths for all ingress-egress pairs.

2. For each pair, obtain the set of links utilised by one or more paths for that pair. This set is called the “link set” for that pair.

3. For each link, obtain its “weight” as the number of all ingress-egress pairs whose link sets contain this link.

On-Line Phase

The on-line phase begins with the arrival of a bandwidth demand for the ingress-egress pair j with a bandwidth demand of D (say). Then:

1. Eliminate all links which have residual capacities less than D units and obtain a reduced network.

2. Update the weight of each link in the reduced network by considering the residual capacity of the link; the weight should increase as the residual capacity decreases.

3. Use the updated weights and apply Dijkstra's algorithm to complete the least-weight path for the ingress-egress pair j.

4. The route for the LSP request is given by the least-weight path above. Finally, the residual capacities of links in the least-weight path are also updated.

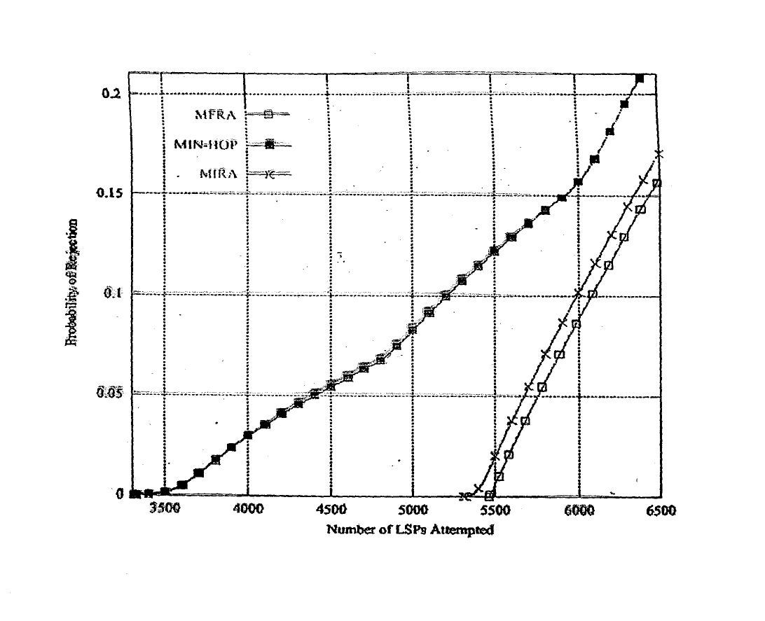

Simulation studies of the algorithm on a variety of networks indicate that its performance is better than that of existing algorithms available in the literature. An example is given in FIG. 3, which in the accompanying illustration shows the comparison of three routing algorithms. Three routing algorithms compared are: Min-Hop, MIRA and MMAFRA. The metric used is the “fraction of arriving LSP requests that are rejected”. The example network is taken from the paper where MIRA was proposed. Even for this network, MAFRA performs better. Secondly, as far as computational speed is concrned, this is a polynomial0time algorithm since it relies on the Dijkstra algorithm whose worst-case running time is known to be a polynomial function of the size of the network.

We claim:

1) A routing method that routes an arrived bandwidth-demand in an unsplit way so as to explicitly maximise the smallest unsplit flow that can be routed in future between all other ingress-egress pairs simultaneously.

2) The routing method of claim 1 further including a method of assigning weights to links for efficient implementation of method in claim 1.
